(19) United States
(12) Patent Application Publication
(10) Pub. No.: US 2021/0056826 A1
(43) Pub. Date: Feb. 25, 2021

(54) INFORMATION PROCESSING APPARATUS, INFORMATION PROCESSING METHOD, AND MEDIUM

(71) Applicant: CANON KABUSHIKI KAISHA

(72) Inventor: Yuzuru Okubo, Kawasaki-shi (JP)

(21) Appl. No.: 16/988,981

(22) Filed: Aug. 10, 2020

(30) Foreign Application Priority Data
Aug. 23, 2019 (JP) 2019-153191

(51) Int. Cl. G08B 21/02; G06K 9/00; G06N 20/00; G06N 5/04

(52) U.S. Cl. CPC G08B 21/0202; G06K 9/00369; G06Q 50/265; G06N 20/00; G06N 5/04; G06K 9/00771

(57) ABSTRACT

An information processing apparatus is provided. The apparatus is operable to perform: receiving, as input data, information of a person and object included in moving image data obtained from an image capturing unit, and estimating a dangerous state using a learned model generated by machine learning of, as supervised data, information representing that the person included in the moving image data is in a dangerous state caused by the object included in the moving image data; and obtaining new moving image data, providing the new moving image data to the estimating, and when information representing that the person included in the new moving image data is in the dangerous state is obtained as a response, issuing a notification.

### BACKGROUND OF THE INVENTION

### Field of the Invention

The present invention relates to an information processing apparatus, an information processing method, and a medium.

### Description of the Related Art

As an increasing number of women work recently, the burden/constraint of childcare is a cause of low birthrate. A cause of the burden/constraint is necessity to always keep watching a child by a childcare provider so that the child does not fall into a dangerous state.

For example, Japanese Patent Laid-Open No. 2018-26006 discloses an apparatus that detects the state of a target person by various sensors and determines using the degree of influence whether the state of the target person is proper.

A method described in Japanese Patent Laid-Open No. 2018-26006 mainly targets an elderly person living alone, and requires as premises a normal life pattern and various sensors corresponding to the life pattern. However, it is difficult to set various sensors in advance for a child requiring childcare in accordance with the life pattern of the child.

### SUMMARY OF THE INVENTION

The present invention detects the dangerous state of a child. Further, the present invention easily collects learning data for determining a dangerous state.

The present invention has the following arrangement. According to one aspect of the present invention, there is provided an information processing apparatus comprising: at least one memory; and at least one processor, wherein the processor executes a program stored in the memory to perform: receiving, as input data, information of a person and object included in moving image data obtained from an image capturing unit, and estimating a dangerous state using a learned model generated by machine learning of, as supervised data, information representing that the person included in the moving image data is in a dangerous state caused by the object included in the moving image data; and obtaining new moving image data, providing the new moving image data to the estimating, and when information representing that the person included in the new moving image data is in the dangerous state is obtained as a response, issuing a notification.

According to the present invention, the dangerous state of a child can be detected. Learning data for determining a dangerous state can also be easily collected.

Further features of the present invention will become apparent from the following description of exemplary embodiments with reference to the attached drawings.

### BRIEF DESCRIPTION OF THE DRAWINGS

FIG. 1 is a view showing an example of the overall configuration of a system according to an embodiment of the present invention;

FIG. 2 is a block diagram showing an example of the hardware arrangement of the system according to the embodiment of the present invention;

FIG. 3 is a block diagram showing an example of the software arrangement of the system according to the embodiment of the present invention;

FIG. 4 is a conceptual view of input data, a learning model, and output data for estimation of the degree of danger according to the embodiment of the present invention;

FIG. 5 is a sequence chart of overall processing of the system according to the first embodiment;

FIG. 6A is a flowchart of a learning phase according to the embodiment of the present invention;

FIG. 6B is a flowchart of the learning phase according to the embodiment of the present invention;

FIG. 7 is a flowchart of an estimation phase according to the embodiment of the present invention;

FIG. 8 is a view showing an example of a UI displayed on a client terminal according to the embodiment of the present invention; and

FIG. 9 is a sequence chart of overall processing of a system according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

[System Configuration]

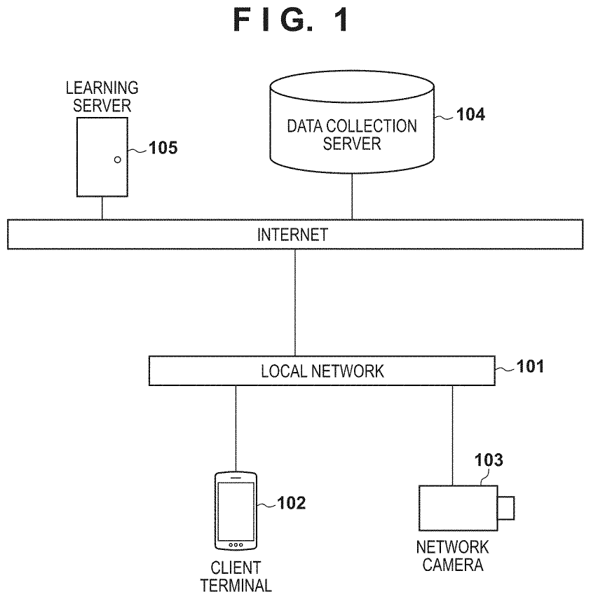

FIG. 1 is a view showing an example of the overall configuration of a system to which the present invention is applicable. In FIG. 1, the system includes a client terminal 102, a network camera 103, a data collection server 104, and a learning server 105. The client terminal 102 and the network camera 103 are connected to a local network 101. The local network 101 is connected to the Internet 100 so as to communicate with it. The client terminal 102 and the network camera 103 can access the learning server 105 and the data collection server 104 via the Internet 100.

The Internet 100 and the local network 101 are so-called communication networks implemented by, for example, LAN, WAN, a telephone line, a dedicated digital line, ATM, a frame relay line, a cable television line, a data broadcasting radio channel, a mobile communication channel, or a combination of them. The communication network does not limit whether it is wired/wireless or its communication standard. The data collection server 104, the learning server 105, the client terminal 102, and the network camera 103 can transmit/receive data to/from each other.

The client terminal 102 is an information processing apparatus and is a desktop computer, a notebook computer, or an information terminal such as a smartphone or a tablet. The client terminal 102 is assumed to incorporate a program execution environment. The client terminal 102 is set as a notification destination when a dangerous state is detected in the system according to the embodiment. The client terminal 102 may be used to obtain in advance the types, positions, and coordinates of furniture, home appliances, and the like falling within the shooting range of the network camera 103.

The network camera 103 is a camera installed indoors or outdoors and shoots a predetermined person (child such as an infant in this case) to be cared. In the embodiment, a target person to be cared and his/her guardian (parent or adult who provides childcare in this case) can be recognized in advance. For example, it is assumed that face information of the child or guardian is registered in advance so that the person can be specified. The network camera 103 can transmit a shot/obtained moving image and related information to the client terminal 102, the learning server 105, and the data collection server 104 via the local network 101 in real time. The shooting range of the network camera 103 is not particularly limited, and a plurality of network cameras 103 may be used to expand the shootable range. Alternatively, the shooting range may be controlled by zoom, pan, and tilt operations or changing the shooting direction or the angle of view in accordance with the functions of the network camera 103.

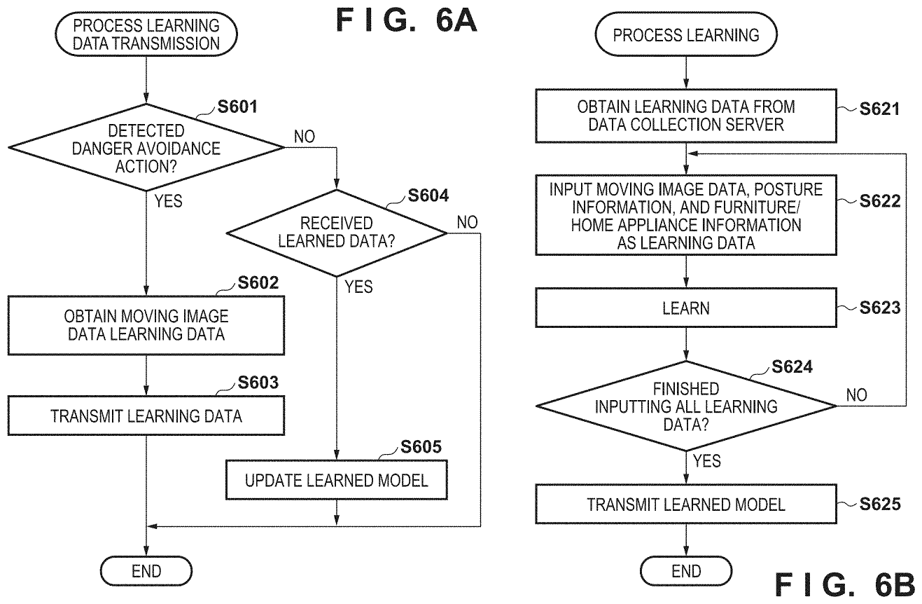

The data collection server 104 receives and collects learning data from the network camera 103. The learning data according to the embodiment includes moving image data of a predetermined time range based on the timing when it is determined that a child fell into a dangerous state, and information of furniture and home appliances around the child. The learning data obtaining method and obtaining timing will be explained with reference to flowcharts (FIGS. 6A and 6B) showing detailed flows of learning data generation to be described later.

The learning server 105 periodically generates a learned model based on stored learning data of the data collection server 104. The learned model generation method will be explained with reference to the flowcharts showing detailed flows of learning in the learning phase in FIGS. 6A and 6B to be described later.

A single apparatus is shown as each apparatus in FIG. 1, but the present invention is not limited to this. For example, various servers may be constituted by a single apparatus, or one server may be constituted by a plurality of apparatuses. A plurality of client terminals 102 and a plurality of network cameras 103 may be used. Learning data according to the embodiment may be collected from a plurality of network cameras 103. A learned model obtained by learning using the learning data collected from the network cameras 103 may be shared between the plurality of network cameras 103.

[Hardware Arrangement]

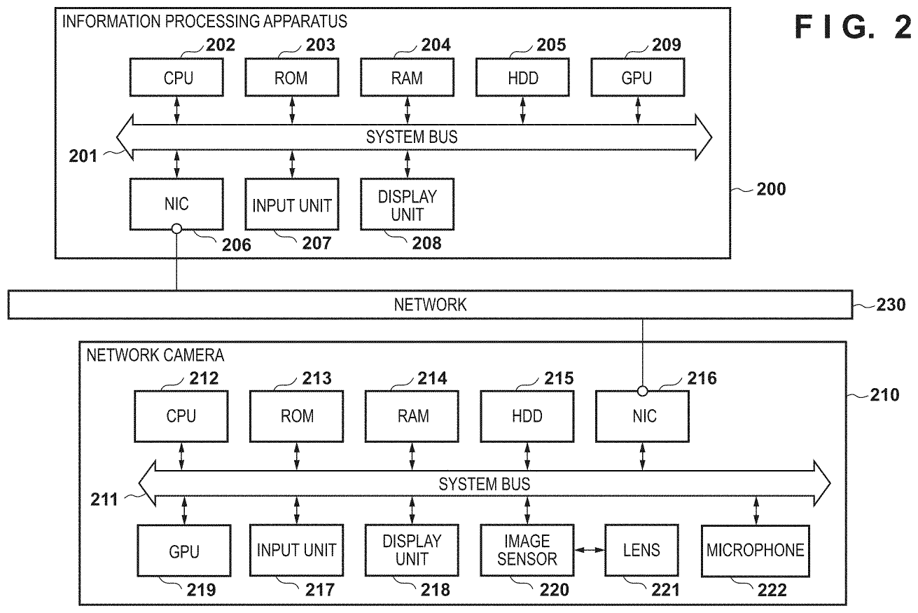

FIG. 2 shows an example of the hardware arrangement of each apparatus according to the embodiment. An information processing apparatus 200 represents an example of the hardware arrangement of the client terminal 102, the data collection server 104, and the learning server 105 according to the embodiment shown in FIG. 1. The client terminal 102, the data collection server 104, and the learning server 105 are described to have the same arrangement in the embodiment, but may have different arrangements.

In the information processing apparatus 200, a CPU (Central Processing Unit) 202 controls the overall apparatus. The CPU 202 reads out application programs, an OS (Operating System), and the like stored in an HDD (Hard Disc Drive) 205, temporarily stores in a RAM (Random Access Memory) 204 information, files, and the like necessary to execute a program, and executes the program.

A GPU (Graphics Processing Unit) 209 performs output processing to a display unit 208, and also performs processing when executing learning a plurality of times using a learning model of machine learning such as deep learning. The GPU 209 can be used to perform parallel processing on much more data and achieve efficient calculation.

A ROM (Read Only Memory) 203 is a nonvolatile storage means and stores various data such as a basic I/O program. The RAM 204 is a temporary storage means and functions as a main memory, a work area, and the like for the CPU 202 and the GPU 209. The HDD 205 is an external storage means, functions as a large-capacity memory, and stores application programs such as a Web browser, programs for service servers, an OS, related programs, and the like. The HDD 205 is not limited to an HDD as long as it is a nonvolatile storage means, and may be, for example, a flash memory.

An input unit 207 is an operation unit configured to accept an operation from a user, and corresponds to, for example, a keyboard or a mouse. The display unit 208 is a display means and serves as the display destination of a command or the like input from the input unit 207 and the output destination of the calculation result of the CPU 202. Note that the input unit 207 and the display unit 208 may be integrated as a touch panel display or the like.

A NIC (Network Interface Controller) 206 exchanges data with an external apparatus via a network 230. The network 230 corresponds to the Internet 100 or the local network 101 shown in FIG. 1. A system bus 201 connects the respective units in the information processing apparatus 200 so that they can communicate with each other, and controls the flow of data between them.

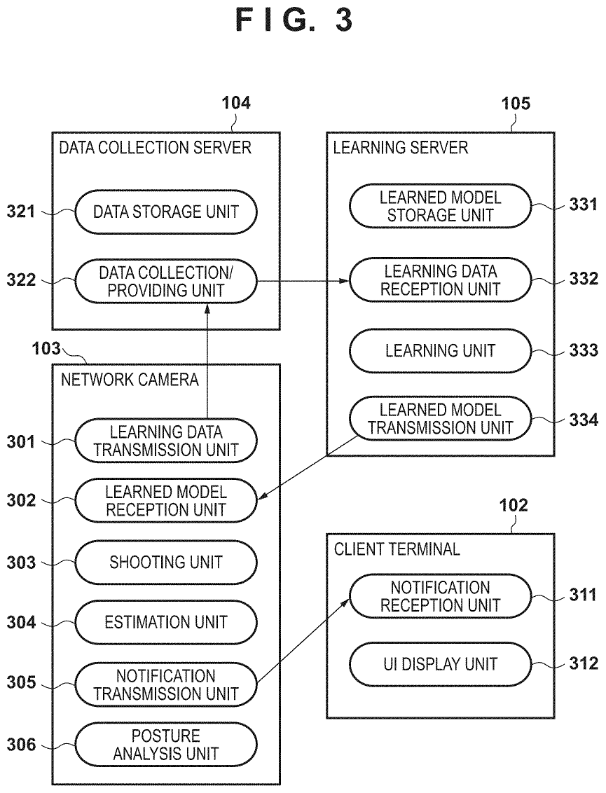

Note that the arrangement of the information processing apparatus 200 is merely an example. For example, the storage destination of data and programs can be changed to the RAM 204, the ROM 203, the HDD 205, or the like in accordance with the features of the data and programs. In addition, the CPU 202 and the GPU 209 execute processing based on programs stored in the HDD 205 to implement processing in a software arrangement as shown in FIG. 3.

A network camera 210 represents an example of the hardware arrangement of the network camera 103 according to the embodiment shown in FIG. 1. One network camera will be exemplified, but when a plurality of network cameras are used, they may have different arrangements.

In the network camera 210, a CPU 212 controls the overall apparatus. The CPU 212 performs control of executing application programs, an OS, and the like stored in an HDD 215, and temporarily storing in a RAM 214 information, files, and the like necessary to execute a program. A ROM 213 is a nonvolatile storage means and stores various data such as a basic I/O program. The RAM 214 is a temporary storage means and functions as a main memory, work area, and the like for the CPU 212.

A GPU 219 performs output processing to a display unit 218, and also performs processing when executing learning a plurality of times using a learning model of machine learning such as deep learning. The GPU 219 can be used to perform parallel processing on much more data and achieve efficient calculation. It is also possible that an external apparatus performs learning and the GPU 219 performs only processing using an already generated learned model.

The HDD 215 is an external storage means, functions as a large-capacity memory, and stores application programs, programs for service servers, an OS, related programs, and the like. The HDD 215 is not limited to an HDD as long as it is a nonvolatile storage means, and may be, for example, a flash memory.

The display unit 218 is a display means and serves as the display destination of a command or the like input from an input unit 217 and the output destination of the calculation result of the CPU 212. Note that the display unit 218 and the input unit 217 may be external ones or provided by an external apparatus. A system bus 211 connects the respective units in the network camera 210 so that they can communicate with each other, and controls the flow of data between them. A NIC 216 exchanges data with an external apparatus via the network 230.

A lens 221 is used to shoot a video around the network camera 210. The video is recorded by reading light coming through the lens 221 by an image sensor 220, and storing the result of reading by the image sensor 220 in the HDD 215 or the RAM 214. This video includes a moving image and a still image.

A microphone 222 obtains a sound around the network camera 103 and a voice such as a conversation. The microphone 222, the lens 221, and the image sensor 220 are operated in combination with each other to function as an image capturing means and simultaneously perform sound recording and picture recording.

Note that the arrangement of the network camera 210 is merely an example. For example, the storage destination of data and programs can be changed to the ROM 213, the RAM 214, the HDD 215, or the like in accordance with the features of the data and programs. In addition, the CPU 212 executes processing based on programs stored in the HDD 215 to implement processing in a software arrangement as shown in FIG. 3. The image sensor 220 and the microphone 222 need not be directly connected to the system bus 211 and for example, may be indirectly connected to the system bus 211 or the CPU 212 via a USB bus or the like. Alternatively, the image sensor 220 and the microphone 222 may be directly connected to the CPU 212 and the GPU 219.

[Software Arrangement]

FIG. 3 shows an example of the software arrangement of each apparatus according to the embodiment. The software of each apparatus is implemented by, for example, reading out a program stored in the storage unit of the apparatus and executing it by the processing unit (for example, CPU) of the apparatus.

The client terminal 102 includes a notification reception unit 311 and a UI display unit 312. The notification reception unit 311 receives a notification transmitted from a notification transmission unit 305 of the network camera 103. Based on the notification received from the notification reception unit 311, the UI display unit 312 causes the display unit 208 to output the contents. As the notification output method of the UI display unit 312, for example, a notification window is displayed on the foreground of the display unit 208 of the client terminal 102, or a childcare provider is notified by a message box or a toast. At this time, instead of simply displaying a message, the notification transmission unit 305 of the network camera 103 may transmit an image or a movie in real time to the notification reception unit 311 of the client terminal 102, and the UI display unit 312 may display the contents. It is also possible to set a threshold on the client terminal 102 with respect to the degree of danger output from an estimation unit 304 of the network camera 103, and adjust an estimated degree of danger to a child, a notification of which is displayed on the UI display unit 312.

The network camera 103 includes a learning data transmission unit 301, a learned model reception unit 302, a shooting unit 303, the estimation unit 304, the notification transmission unit 305, and a posture analysis unit 306.

The learning data transmission unit 301 determines, based on a moving image and voice obtained by the shooting unit 303, whether a childcare provider took a danger avoidance action for a target child. The danger avoidance action is, for example, an action in which the childcare provider shouts or an action in which the childcare provider quickly evacuates the target child from a dangerous object. For example, thresholds for the volume of vocalization, the duration of vocalization, the moving distance, and the moving speed may be set in advance, and a danger avoidance action may be determined by comparison with the thresholds. The learning data transmission unit 301 cuts out a moving image of a predetermined time section based on the timing when the danger avoidance action occurred. For example, when a moving image of 15 frames per sec is shot and a moving image of past three seconds is cut out, moving image data of 45 frames before the occurrence of the danger avoidance action is obtained. Note that the range of obtaining moving image data is not particularly limited. For example, moving image data and the like may be recorded sequentially, and at the timing when a danger avoidance action is detected, moving image data recorded in a predetermined period before and after the timing may be set as learning data. Moving image data and the like not set as learning data may be discarded over time. The learning data transmission unit 301 transmits cutout moving image data, an analysis result obtained by the posture analysis unit 306, and surrounding furniture/home appliance information as learning data to a data collection/providing unit 322 of the data collection server 104.

The learned model reception unit 302 periodically receives a learned model used in the estimation unit 304 from a learned model transmission unit 334 of the learning server 105. The learned model may be received by periodically sending a request from the network camera 103 side to the learning server 105, or waiting for a learned model periodically transmitted from the learning server 105.

The shooting unit 303 converts the result of reading by the image sensor 220 into a video signal and stores the video signal in the HDD 215. The shooting unit 303 transfers the video signal to the estimation unit 304 in real time. The shooting unit 303 detects furniture/home appliance information about furniture and home appliances within the shooting range by object detection processing. The object detection processing performed by the shooting unit 303 need not be performed every frame. For example, when a background image changes at a predetermined ratio, the object detection processing may be performed. As a concrete object recognition processing method, for example, a sliding window is used, an HOG (Histograms of Oriented Gradients) feature amount is detected, and machine learning is performed. Alternatively, image information is directly machine-learned using CNN (Convolutional Neural Network). Note that another method may be adopted as long as object recognition is performed. For example, even an object area candidate may be detected by CNN to improve the performance, or a physical identifier (marker) such as QR Code® may be attached to a furniture/home appliance.

The estimation unit 304 receives a video signal from the shooting unit 303, position information and posture vector data of a target person from the posture analysis unit 306, and surrounding furniture/home appliance information. The estimation unit 304 estimates whether the target person is in a dangerous state, by using these inputs and a learned model obtained from the learned model transmission unit 334 of the learning server 105. The estimation unit 304 and a learning unit 333 of the learning server 105 perform learning and estimation using machine learning in order to determine whether the target person is in a dangerous state. Examples of the algorithm are the nearest neighbor method, naive Bayes method, decision tree, and support vector machine (SVM). A feature amount for learning using a neural network, and deep learning of generating a coupling weighting factor are also applicable. Available ones of these algorithms can be used and applied to the embodiment, as needed.

Processing by the estimation unit 304 may use the GPU 219 in addition to the CPU 212. More specifically, when executing an estimation program including a learning model, estimation is done by performing calculation by the CPU 212 and the GPU 219 in cooperation. Note that only the CPU 212 or the GPU 219 may perform the calculation in processing by the estimation unit 304. The learning unit 333 of the learning server 105 (to be described later) may also use the GPU 209.

When the estimation unit 304 estimates that a child serving as a target person is in a dangerous state, the notification transmission unit 305 issues a danger notification to the notification reception unit 311 of the client terminal 102. The notification transmission unit 305 may transmit moving image data of the shooting unit 303 together with information of the danger notification.

The posture analysis unit 306 analyzes the position and posture of a person within the shooting range based on moving image data obtained by the shooting unit 303. The posture analysis unit 306 recognizes a moving object from difference images between frames of the moving image data obtained by the shooting unit 303, and analyzes the detected moving object, thereby estimating the posture of the person. Information obtained as the result of analysis by the posture analysis unit 306 serves as position information and posture vector data of the person. These pieces of information will be collectively called “posture information”.

The data collection server 104 includes a data storage unit 321 and the data collection/providing unit 322.

The data storage unit 321 stores learning data transmitted from the learning data transmission unit 301 of the network camera 103 via the data collection/providing unit 322. The data collection/providing unit 322 receives learning data transmitted from the learning data transmission unit 301 of the network camera 103. The data collection/providing unit 322 transmits learning data to a learning data reception unit 332 in accordance with a request from the learning server 105.

The learning server 105 includes a learned model storage unit 331, the learning data reception unit 332, the learning unit 333, and the learned model transmission unit 334.

The learned model storage unit 331 stores a learned model as the result of learning by the learning unit 333. The learning data reception unit 332 periodically requests learning data of the data collection/providing unit 322 of the data collection server 104. “Periodically” may be a preset time interval or a timing when a predetermined amount of data or more is collected in the data collection server 104. The learning data reception unit 332 inputs learning data received from the data collection/providing unit 322 to the learning unit 333, and requests the learning unit 333 to perform learning processing.

The learning unit 333 learns based on machine learning using received learning data. The learning unit 333 may include an error detection unit and update unit (neither is shown) corresponding to a learning method. The error detection unit obtains an error between supervised data, and data output from the output layer of a neural network in accordance with data input to the input layer. The error detection unit may calculate an error between supervised data and output data from the neural network by using a loss function. The update unit updates a coupling weighting factor between nodes of the neural network, and the like based on the error obtained by the error detection unit so as to decrease the error. The update unit updates the coupling weighting factor and the like using, for example, error backpropagation. The error backpropagation is a method of adjusting a coupling weighting factor between nodes of each neural network, and the like so as to decrease the error. In the embodiment, supervised data is set so that output data upon learning using learning data transmitted from the learning data transmission unit 301 of the network camera 103 when it is determined that a target person is in a dangerous state represents a high degree of danger. The learning unit 333 updates the coupling weighting factor and the like so as to come close to the value of the supervised data.

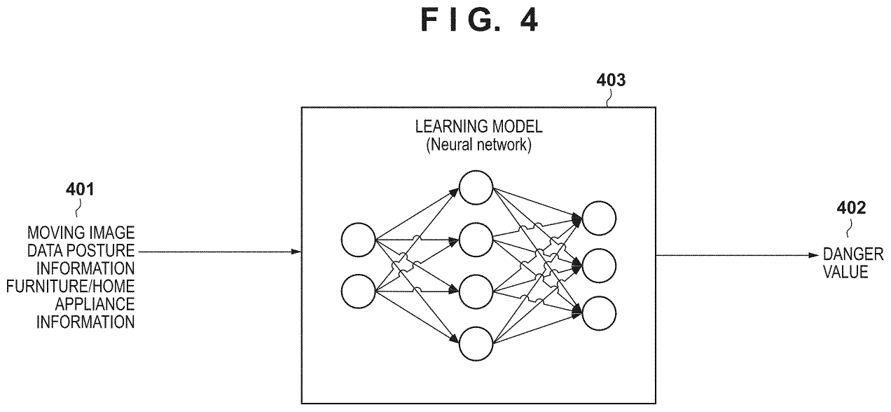

FIG. 4 is a conceptual view showing the relationship between input/output, and a learning model used in the learning unit 333 and the estimation unit 304. A learning model 403 corresponds to a learning model used in the learning unit 333. Input data 401 is learning data transmitted from the learning data transmission unit 301 of the network camera 103 to the data collection/providing unit 322 of the data collection server 104. The learning data according to the embodiment includes moving image data shot by the shooting unit 303 in a predetermined period based on the timing when a childcare provider took a danger avoidance action for a target child. Further, the learning data includes posture information of the child obtained by the posture analysis unit 306, and furniture/home appliance information about furniture and home appliances positioned around the child.

Output data 402 is a danger value estimated by the estimation unit 304 using the learning model 403 based on the input data 401, and represents the degree of danger to the child. The danger value is the result of regression analysis by the estimation unit 304 and is assumed to take a continuous value. For example, when the child is surely in a dangerous state, the degree of danger takes “1.0”. On the contrary, when the child is surely in a safe state, the danger value is expressed as “0.0”. Note that the danger value need not always take a continuous value depending on the method of notification to the client terminal 102. For example, if the client terminal 102 simply receives danger notifications, states of the child may be classified into two, dangerous and non-dangerous states. The learning model 403 may be prepared for each of furniture and home appliances, or a danger value for each of furniture and home appliances may be used as the output data 402. By performing learning using the learning model 403 and learning data, a learned model is generated and provided from the learning server 105 to the network camera 103.

[Sequence]

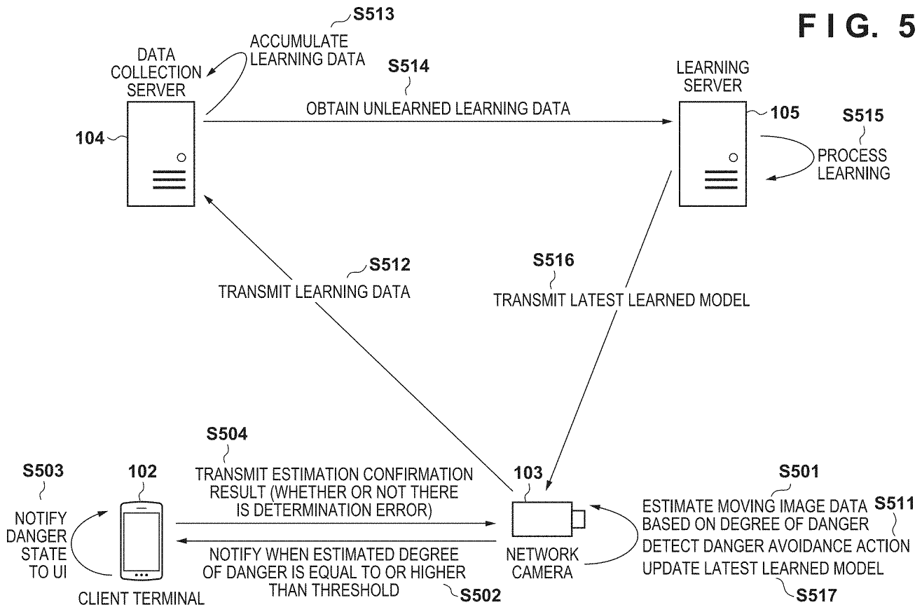

A sequence in which when a child is in a dangerous state, the system according to the embodiment notifies a childcare provider of the dangerous state will be described with reference to FIG. 5. A learning data collection method and a sequence of learning of a learning model will also be explained.

In step S501, the estimation unit 304 of the network camera 103 estimates the degree of danger of a target child using a learned model based on, as input data, moving image data, posture information, and furniture/home appliance information. Assume that the network camera 103 has already held a learned model generated using past learning data.

In step S502, the notification transmission unit 305 of the network camera 103 accepts as a response the result of estimation of the degree of danger by the estimation unit 304 in step S501, and if the degree of danger exceeds a threshold, transmits a notification to that effect to the notification reception unit 311 of the client terminal 102. The notification contents may include the degree of danger and the moving image data.

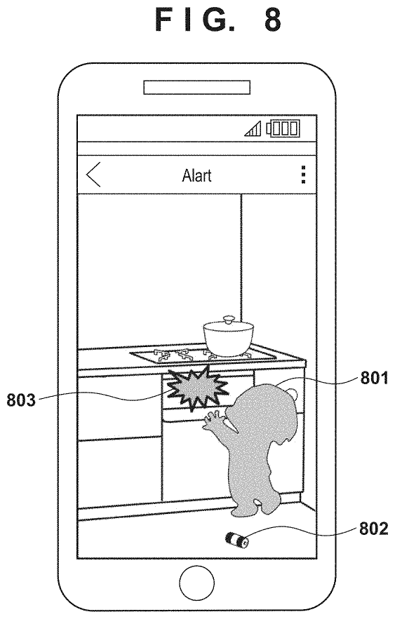

In step S503, the client terminal 102 displays, on the UI display unit 312 based on the notification contents received in step S502, a message that the target child is in a dangerous state. At this time, the client terminal 102 may change the notification method on the UI display unit 312 in accordance with the value of the degree of danger, in addition to displaying the dangerous state. For example, when the degree of danger is lower than 0.9 and equal to or higher than 0.7, a window, message box, toast, or icon notifying the user of danger may be displayed on the UI display unit 312. When the degree of danger is equal to or higher than 0.9, an alarm may be further sounded to notify the user that the target child is highly likely to be in a dangerous state. Further, a most dangerous combination of furniture and home appliances out of posture information and furniture/home appliance information may be highlighted and displayed on the UI display unit 312. A display example of the UI will be described later with reference to FIG. 8.

In step S504, the client terminal 102 transmits, to the network camera 103, the evaluation contents of the user with respect to the notification contents received in step S502. As the contents to be transmitted, for example, a user's evaluation to the correctness of whether the result of estimation by the network camera 103 was correct may be sent back. The learning data transmission unit 301 of the network camera 103 can further improve the precision of the learned model by using the evaluation result from the client terminal 102 as a trigger of learning data collection and supervised data. That is, when the user designates the estimation to be incorrect, learning data including a message to that effect is transmitted to the data collection server 104. Then, supervised data may be set so that output data obtained by learning using the learning data represents a low degree of danger. This step can expect an effect of further improving the precision of the learned model, but is not essential in the embodiment.

Next, the sequence of learning of a learning model will also be explained. In step S511, the learning data transmission unit 301 of the network camera 103 analyzes operation data obtained by the shooting unit 303, and determines whether a danger avoidance action was took. If the learning data transmission unit 301 detects that a danger avoidance action was took, it obtains moving image data of a predetermined period based on the timing when the danger avoidance action was took.

In step S512, the learning data transmission unit 301 of the network camera 103 transmits, as learning data to the data collection/providing unit 322 of the data collection server 104, moving image data of the predetermined period based on the timing when the danger avoidance action was took, posture information, and furniture/home appliance information.

In step S513, the data collection server 104 stores the learning data received in step S512 in the data storage unit 321.

In step S514, the learning data reception unit 332 of the learning server 105 periodically obtains unlearned learning data from the data collection/providing unit 322 of the data collection server 104. As the obtaining timing, the learning server 105 may request learning data of the data collection server 104 in every predetermined period. Alternatively, the data collection server 104 may transmit learning data in every predetermined period or at the timing when a predetermined amount of data is collected. Note that the data collection server 104 may discard learning data transmitted to the learning server 105, or may record that learning data was transmitted and keep holding it. The learning data reception unit 332 requests the learning unit 333 of the learning server 105 to learn using the obtained learning data.

In step S515, the learning unit 333 of the learning server 105 learns using the learning data obtained from the data collection server 104 in step S514.

In step S516, the learned model transmission unit 334 of the learning server 105 transmits a learned model serving as the result of learning by the learning unit 333 to the learned model reception unit 302 of the network camera 103. The learned model reception unit 302 updates the learned model used in the estimation unit 304 to the received learned model. The learned model before update may be held as a history or discarded.

[Processing Procedure]

(Learning Processing)

FIGS. 6A and 6B are flowcharts showing the detailed procedure of learning in the learning phase. FIG. 6A is a flowchart of processing by the learning data transmission unit 301 of the network camera 103. The processing in FIG. 6A is periodically repeated in the network camera 103.

In step S601, the learning data transmission unit 301 determines, from moving image data obtained from the shooting unit 303 or voice data obtained from the microphone 222, whether a childcare provider took a danger avoidance action for a target child. The danger avoidance action is, for example, an action in which the childcare provider shouts, an action in which the target child keeps crying loudly for a predetermined time, or an action in which the childcare provider quickly evacuates the target child from a dangerous object. An action in which the childcare provider not only quickly evacuates the child from a dangerous object, but also moves the dangerous object away from the child may also be detected as the danger avoidance action. If the danger avoidance action is detected (YES in step S601), the process advances to step S602. If no danger avoidance action is detected (NO in step S601), the process advances to step S604.

In step S602, the learning data transmission unit 301 obtains, from the HDD 215, frames of moving image data of a predetermined time before and after the timing when the danger avoidance action was detected.

In step S603, the learning data transmission unit 301 transmits, as learning data to the data collection/providing unit 322 of the data collection server 104, the moving image data obtained in step S602, posture data at the timing when the danger avoidance action was detected, and furniture/home appliance information. An instantaneous value at the timing when the danger avoidance action was detected is transmitted as the posture data, but frames of the posture data of a predetermined time may be transmitted to the data collection/providing unit 322, similar to the moving image data. Then, the processing procedure ends.

In step S604, the learned model reception unit 302 determines whether it has received a learned model from the learned model transmission unit 334 of the learning server 105. If it is determined that the learned data has been received (YES in step S604), the process advances to step S605. If it is determined that the learned data has not been received (NO in step S604), the processing procedure ends.

In step S605, the learned model reception unit 302 stores the received learned model in the HDD 215 or the RAM 214 so that the estimation unit 304 can use it, thereby updating the learned model. The learned model before update may be held as a history or discarded.

FIG. 6B is a flowchart of learning processing by the learning server 105.

In step S621, the learning data reception unit 332 obtains learning data from the data collection/providing unit 322 of the data collection server 104.

In step S622, the learning unit 333 uses, as input data, learning data (moving image data, posture information, and furniture/home appliance information) received in step S621 and, as supervised data, information (degree of danger) representing whether the child is in a dangerous state. Table 1 shows concrete examples of data used as the input data and the supervised data.

A learning data ID is an ID (IDentification information) representing a pair of input data and supervised data. The ID assignment rule is not particularly limited as long as a pair of input data and supervised data can be uniquely specified. In the embodiment, moving image data, posture data, and furniture/home appliance information are used as input data, as described above. The moving image data is moving image data in a predetermined time based on the timing when the learning data transmission unit 301 of the network camera 103 detected a danger avoidance action. The posture data is posture information analyzed by the posture analysis unit 306 at this timing. In the embodiment, the posture information is expressed by vectors of numerical values representing the joint and bone position of a human. As for the furniture/home appliance information, the distance of a furniture/home appliance closest to a target child is defined as “1.0”, and the distance of another furniture/home appliance is represented relatively to the closest furniture/home appliance. For example, when a home appliance A is positioned at a distance of 0.5 m from a child and a home appliance B is positioned at a distance of 2 m from the child, the distance to the home appliance A is expressed as “1.0” and the distance to the home appliance B is expressed as “4.0”. Note that the furniture/home appliance information is not limited to the distance and may include information about the positional relationship between a person and a furniture/home appliance.

As the supervised data, the degree of danger is used. The degree of danger has been described with reference to FIG. 4, so a detailed description thereof will not be repeated. As the supervised data, the value of the degree of danger is “1.0” when a danger avoidance action was took, and “0.0” with respect to steady-state learning data when no danger avoidance action was took. For example, supervised data (degree of danger) may be set as “0.0” with respect to learning data corresponding to a case in which the user evaluates in step S504 of FIG. 5 that estimation is incorrect. To the contrary, when the user evaluates that estimation is correct or when no evaluation is performed in step S504, supervised data (degree of danger) may be set as “1.0”.

TABLE 1

| | Input Data | | | Supervised |
|---|---|---|---|---|
| | Moving | | Furniture/Home | Data |
| Learning | Image | Posture | Appliance | Degree of |
| Data ID | Data | Data | Information | Danger |
| 1 | <Moving | <Posture | Table: 1.0 | 0.0 |
| | image | vector 1> | Stove: 2.0 | |
| | data 1> | | Battery: 10.0 | |
| 2 | <Moving | <Posture | Table: 1.0 | 1.0 |
| | image | vector 2> | Stove: 2.3 | |
| | data 2> | | Battery: 12.0 | |
| . | . | . | . | . |
| . | . | . | . | . |
| . | . | . | . | . |
| N | <Moving | <Posture | Table: 10.0 | 1.0 |
| | image | vector N> | Stove: 1.0 | |
| | data N> | | Battery: 12.0 | |

In step S623, the learning unit 333 learns using the information set in step S622. As described above, the learning method is not particularly limited.

In step S624, the learning unit 333 determines whether learning using all learning data has been completed. If the learning unit 333 determines that unprocessed learning data is left (NO in step S624), the process returns to step S622 to repeat the processing on the unprocessed learning data. If the learning unit 333 determines that learning using all learning data has been completed (YES in step S624), the process advances to step S625.

In step S625, the learned model transmission unit 334 transmits a new learned model to the learned model reception unit 302 of the network camera 103. Then, the processing procedure ends.

(Estimation Processing)

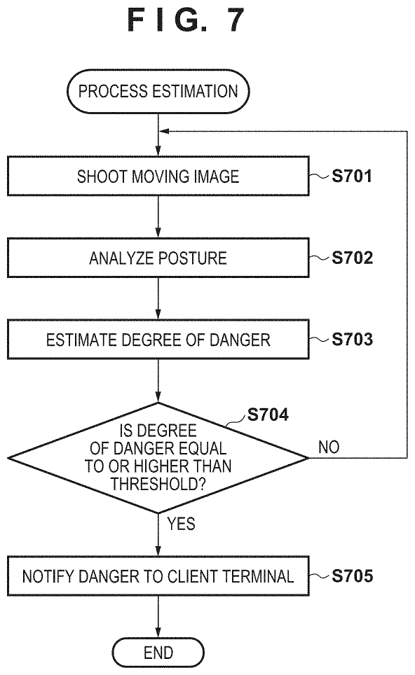

FIG. 7 is a flowchart showing the detailed procedure of estimation processing by the network camera 103. This processing procedure is regularly executed by the network camera 103.

In step S701, the shooting unit 303 of the network camera 103 performs shooting processing and obtains moving image data. At this time, shooting data of a predetermined period is required as moving image data necessary for the estimation unit 304, so shot moving image data is properly stored in the HDD 215 or the RAM 214.

In step S702, the posture analysis unit 306 performs posture analysis based on the moving image data shot in step S701. As a result of the posture analysis of the posture analysis unit 306, the position and posture vector of a target child are obtained.

In step S703, the estimation unit 304 uses, as input data, the information about the posture obtained in steps S701 and S702 and furniture/home appliance information obtained in advance, and performs estimation using a learned model received from the learned model transmission unit 334 of the learning server 105. As a result of estimation, the estimation unit 304 outputs the degree of danger representing whether the target child is in a dangerous state.

In step S704, it is determined whether the degree of danger estimated in step S703 is equal to or higher than a threshold. If it is determined that the degree of danger is equal to or higher than the threshold (YES in step S704), the process advances to step S705. If it is determined that the degree of danger is lower than the threshold (NO in step S704), the process returns to step S701 to repeat the processing. The threshold may be defined in advance and held in a storage unit such as the HDD 215, or may be dynamically settable by the user (for example, childcare provider).

In step S705, the notification transmission unit 305 transmits, to the notification reception unit 311 of the client terminal 102, the estimation result representing that the target child is in the dangerous state. The data transmitted from the notification transmission unit 305 to the client terminal 102 may include the degree of danger obtained as a result of estimation in step S703, real-time moving image data, and area information of a furniture/home appliance considered to be the cause of the danger. In the embodiment, the area information of a furniture/home appliance is area information representing the position of a furniture/home appliance having a highest degree of association (shortest distance) obtained at the time of estimating the degree of danger in step S703.

FIG. 8 shows an example of the UI display when issuing a danger notification in the client terminal 102. FIG. 8 shows an example of a screen displayed on the UI display unit 312 of the client terminal 102.

In the example of FIG. 8, a stove 803 and a battery 802 are displayed near a child 801. The child 801 takes a posture of raising his/her arm. These images are displayed on the UI display unit 312 based on real-time moving image data transmitted in step S705. For example, in FIG. 8, when the stove 803 is highly likely to be a cause of danger as a result of estimation of the degree of danger from moving image data, posture information, and furniture/home appliance information, the area of the stove 803 is highlighted and displayed as area information. To the contrary, when the child takes a posture of squatting, not the area of the stove 803 but the area of the battery 802 may be highlighted and displayed as area information. The highlighting processing can notify the childcare provider of the cause of danger. Note that the FIG. 8 shows merely an example of the display, and a furniture/home appliance to be highlighted may be decided based on the learning result in practice.

According to the embodiment, a childcare provider can be notified whether a child requiring childcare is in a dangerous state. Further, learning data used to generate a learned model for determining a dangerous state can be easily collected. The knowledge of another childcare provider can be utilized by sharing the model learned using the learning data. This can improve the dangerous state estimation precision.

### Second Embodiment

In the first embodiment, an embodiment in which the notification destination when the degree of danger is equal to or higher than a threshold is assumed to be the client terminal 102 was described. Recently, various home appliances are connected to the Internet and an increasing number of home appliances can collect various sensor values via the Internet or be controlled externally. Information acquisition or control via the Internet is called IoT (Internet of Things). Devices compatible with IoT are called IoT-compatible devices. According to the second embodiment of the present invention, an embodiment in which notification destinations include an IoT-compatible device and the IoT-compatible device is controlled in accordance with the degree of danger will be described. Note that a description of the same arrangement as that in the first embodiment will not be repeated and only a difference will be described.

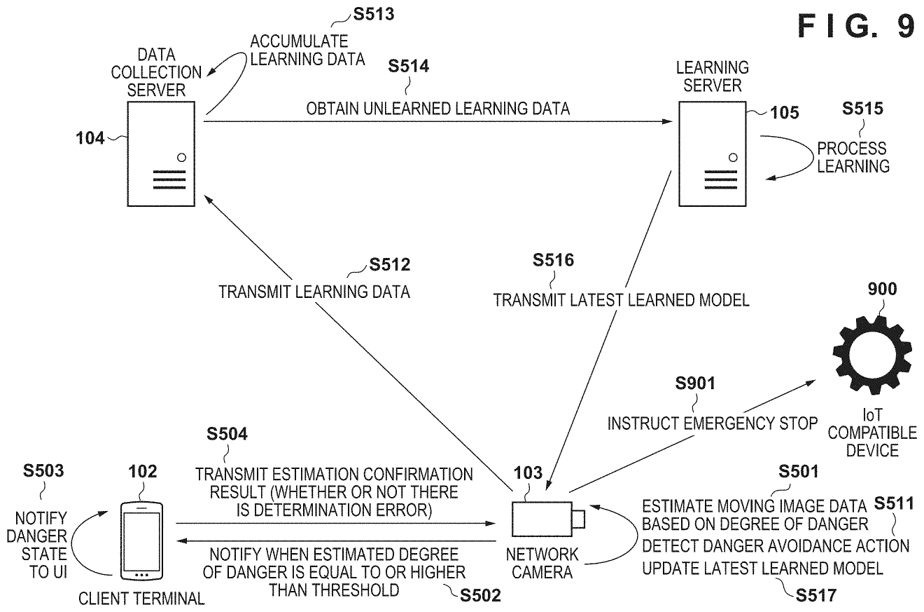

The operation of a system according to the second embodiment will be explained with reference to FIG. 9. In a processing sequence shown in FIG. 9, the same reference numerals as those in the first embodiment denote the same processes. In the second embodiment, the system includes an IoT-compatible device 900. The type of the IoT-compatible device 900 is not particularly limited. The system may include a plurality of IoT-compatible devices 900, and a network camera 103 manages information about the notification destination.

As described in the first embodiment, a client terminal 102 is notified of danger in step S502. At this time, information of a furniture/home appliance that is highly likely to be the cause of danger is transmitted to the client terminal 102. Assume that the furniture/home appliance assumed to be the cause of danger is the IoT-compatible device 900 and the IoT-compatible device 900 has an emergency stop function.

In step S901, the notification transmission unit 305 of the network camera 103 issues the notification to the client terminal 102 in step S502, and issues an emergency stop instruction to the target IoT-compatible device 900. The operation of the IoT-compatible device 900 is controlled in accordance with the emergency stop instruction so as to cancel the dangerous state. The target IoT-compatible device 900 is equivalent to an IoT-compatible device serving as a furniture/home appliance having a highest degree of association (shortest distance). The present invention is not limited to the arrangement in which the network camera 103 directly transmits an emergency stop instruction to the IoT-compatible device 900. For example, an emergency stop instruction to the target IoT-compatible device 900 may be transmitted to a server (not shown) on the Internet 100 that manages the IoT-compatible device 900. The position of the IoT-compatible device 900 in the shooting range can be grasped by object detection processing performed by the shooting unit 303.

As described above, according to the embodiment, when a child requiring childcare is in a dangerous state and a furniture/home appliance likely to be the cause of the dangerous state is an IoT-compatible device, emergency stop is automatically designated from a remote place, and an injury or the like can be highly likely to be prevented from occurring.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-153191, filed Aug. 23, 2019 which is hereby incorporated by reference herein in its entirety.

What is claimed is:

1. An information processing apparatus comprising:
at least one memory; and
at least one processor,
wherein the processor executes a program stored in the memory to perform:
receiving, as input data, information of a person and object included in moving image data obtained from an image capturing unit, and estimating a dangerous state using a learned model generated by machine learning of, as supervised data, information representing that the person included in the moving image data is in a dangerous state caused by the object included in the moving image data; and
obtaining new moving image data, providing the new moving image data to the estimating, and when information representing that the person included in the new moving image data is in the dangerous state is obtained as a response, issuing a notification.

2. The apparatus according to claim 1, wherein the processor further performs:
obtaining moving image data from the image capturing unit;
specifying a person and object included in the moving image data;
detecting a predetermined action by the person included in the moving image data based on information of the specified person and object; and
when the predetermined action is detected, generating, as learning data, the moving image data and the information of the specified person and object.

3. The apparatus according to claim 2, wherein the predetermined action includes vocalization of the person louder than a predetermined volume, vocalization of the person longer than a predetermined period, and movement of another person by the person from the object to a position apart at not less than a predetermined distance.

4. The apparatus according to claim 2, wherein a value of supervised data when performing machine learning using the moving image data in the generated learning data is set to have high possibility of a dangerous state.

5. The apparatus according to claim 2, wherein the specifying includes specifying a posture of the person included in the moving image data, and a distance between the person and object included in the moving image data.

6. The apparatus according to claim 2, wherein the processor further performs:
providing the generated learning data to an external apparatus; and
receiving a learned model generated by machine learning using the provided learning data, and
the estimating includes updating a held learned model with the received learned model.

7. The apparatus according to claim 1, wherein the processor further performs accepting, from a notification destination, evaluation of correctness to a result of determining by the estimating that the person is in the dangerous state, and
a value of supervised data when performing machine learning using the moving image data in the learning data is set based on the evaluation of correctness.

8. The apparatus according to claim 1, wherein a notification destination is a client terminal, and
the issuing a notification includes issuing a notification to display, on the client terminal, the moving image data and information of an object serving as a cause of a predetermined state.

9. The apparatus according to claim 1, wherein a notification destination is an IoT (Internet of Things)-compatible device, and
notification means transmits an instruction of an operation to the IoT-compatible device to cancel the dangerous state.

10. The apparatus according to claim 1, wherein the information processing apparatus is a network camera including the image capturing unit.

11. An information processing method comprising:
receiving, as input data, information of a person and object included in moving image data obtained from an image capturing unit, and estimating a dangerous state using a learned model generated by machine learning of, as supervised data, information representing that the person included in the moving image data is in a dangerous state caused by the object included in the moving image data; and
executing the estimating when new moving image data is obtained, and when information representing that the person included in the new moving image data is in the dangerous state is obtained as a response, issuing a notification.

12. A non-transitory computer-readable medium storing a program, when the program is executed, the program causing a computer to:
receive, as input data, information of a person and object included in moving image data obtained from an image capturing unit, and estimate a dangerous state using a learned model generated by machine learning of, as supervised data, information representing that the person included in the moving image data is in a dangerous state caused by the object included in the moving image data; and
obtain new moving image data, provide the new moving image data to the estimate, and when information representing that the person included in the new moving image data is in the dangerous state is obtained as a response, issue a notification.
